(19) United States
(12) Patent Application Publication
(10) Pub. No.: US 2026/0348867 A1
(43) Pub. Date: Nov. 5, 2026

(54) METHOD FOR CHECKING THE ADHESION BETWEEN LAYERS OF A CONSTRUCTION PANEL, AND CORRESPONDING DEVICE

(71) Applicant: SAINT-GOBAIN PLACO, Courbevoie (FR)

(72) Inventors: Valentine HERVIO, Courbevoie (FR); Hamouda JAFFEL, Courbevoie (FR); Tilo STANOSSEK, Duesseldorf (DE); Andreas SCHULTZE, Duesseldorf (DE)

(73) Assignee: SAINT-GOBAIN PLACO, Courbevoie (FR)

(21) Appl. No.: 19/131,368

(22) PCT Filed: Oct. 31, 2023
(86) PCT No.: PCT/FR2023/051719

§ 371 Date: May 20, 2025

(30) Foreign Application Priority Data
Nov. 24, 2022 (FR) FR2212255

(51) Int. Cl. G01N 21/88; G01N 21/84

(52) U.S. Cl. CPC G01N 21/8851; G01N 2021/8472; G01N 2021/888; G01N 2021/8887

(57) ABSTRACT

A device for checking a bond between two layers of materials of a construction panel formed by cutting, on a production line, a flow of layers of materials that are stacked and bonded together, so as to produce construction panels provided with edge surfaces, includes: a device for detecting a bonding defect between the two layers of materials having a device for capturing an image of an edge surface of the construction panel, and a device for analyzing the captured image.

The present invention relates to the construction industry and in particular to the manufacture of construction panels based on plaster or another material such as cement. The invention relates more specifically to:
a method for checking a bond between a layer of a material such as plaster and outer layers of material which grip this layer of material, these different layers constituting such a construction panel,
an associated checking device and
a method for manufacturing such panels.

In particular, the plaster-based construction panels are manufactured on a production line by spreading an inner layer of plaster mixed with water on an outer layer of paper or glass-fiber material, and then covering this inner layer with another outer layer of paper or glass-fiber material. These inner and outer layers are then dried and cut into construction panels. The outer layers adhere to the inner layer by entangling plaster crystals around the paper or glass fibers of the outer layers, this entanglement is encouraged by the hydration of the materials, which allows the formation of crystals and pores between these crystals. A poor adhesion between these layers leads to a detachment of the outer layers, which is particularly damaging when it comes to drying panels or packaging them.

Currently, in order to check the quality of the bond between the inner layer of plaster and the outer layers of paper on a construction panel, an operator makes crosses on the surface of the panel that he samples on the production line, and tries to detach the paper off this surface, or tries to detach the paper off directly from the edge of the panel. If the operator is able to detach off all the paper, without leaving an under-thickness of paper stuck to the plaster, then the bond between the inner layer of plaster and the layers of paper on the construction panel is not satisfactory. Otherwise, the quality of the bond is deemed satisfactory. These manual checks are therefore time-consuming, and may not be repeated identically, as the force and speed of detachment depend in particular on the operator.

In addition, this type of check is carried out on a damp construction panel, often before the construction panel has dried, i.e. before the bonds between the plaster and paper crystals have fully formed. One of the reasons for this is to avoid blocking the dryers by the paper detaching off as the panel dries. These prior art checks are performed randomly on a few construction panels, at different points on the production line, the frequency of these checks being a function of the variability of the materials used and the stability of the production process on this production line. The bond between the materials of the different panels checked is therefore not at the same stage of formation at the time of these checks. The mere time taken by an operator to check a panel influences the quality of the bond, which he will assess manually. Similar checks are carried out during the manufacture of plaster panels covered with glass fiber.

These prior art checks therefore do not allow to quantify the quality of the bond between the different materials of a construction panel, and even less to carry out a reliable quantification carried out identically for all the construction panels of a production line.

The aim of the present invention is to remedy, at least in part, the disadvantages of the prior art, by providing a method for checking a bond between the layers of a construction panel, an associated device and a method for manufacturing a construction panel incorporating such a checking method, which allow to quantify the quality of the bond between the layers of the construction panel with greater reliability.

To this end, the invention proposes a method for checking a bond between at least two layers of materials of a construction panel formed by cutting, on a production line, a flow of layers of materials stacked and bonded together, so as to produce construction panels provided with edges surfaces, the checking method comprising a step of detecting a bonding defect between the two layers of materials, the checking method being characterized in that the detection step comprises sub-steps:
capturing an image of an edge surface of the construction panel, and
analyzing the image thus captured.

Thanks to the invention, checking for good adhesion between a layer of plaster or cement in the construction panel and an outer layer of the construction panel made of paper or glass-fiber material is performed in the same way on the panels in the production line, without manual tearing of an outer layer of a construction panel. The image capture is used to detect a natural detachment of material layers due to insufficient formation of the bond between these material layers. Preferably, the detection step takes place at the same point in the production line for all the construction panels being checked. Even more preferably, each panel of the production line is checked by the checking method according to the invention.

It should be noted that the construction panel may comprise layers of materials other than plaster and paper or a glass fiber-based material, the invention being applicable to any type of construction panel whose manufacture may lead to problems of detachment between the layers of materials. For example, the construction material comprises an inner layer of cement covered with outer layers of paper or glass fiber.

According to an advantageous characteristic of the method for checking a bond according to the invention, the sub-step of capturing an image is preceded by a sub-step of sending a gas onto the edge surface of the construction panel. This gas is, for example, air or water vapor. Sending water vapor may prevent the panel from overheating during a subsequent drying step.

This sub-step of sending a gas encourages the detachment of the layers of material when they do not have a bond strong enough to prevent this detachment, and therefore allows to quantify the quality of this bond. It should be noted that this detachment takes place naturally between the layers of different materials, and not between two sub-thicknesses of paper as may happen with manual tearing of the paper on a construction panel in the prior art.

According to another advantageous characteristic of the method for checking a bond according to the invention, during the sub-step of sending the gas, the gas is sent at a predetermined pressure of between 1 and 6 bar. This relative pressure (i.e. added to the atmospheric pressure) is, for example, maintained at the same value throughout the detection step, or is modulated according to the arrival of the construction panel in front of a camera implementing the image capture sub-step. For example, this pressure changes according to a pressure ramp. A position sensor for the construction panel on the production line may preferably be used to interrupt the sending of pressurized gas between two detection steps.

According to another advantageous characteristic of the method for checking a bond according to the invention, the analysis sub-step provides a value representative of a level of detachment between the two layers of materials over at least a part of the edge surface, and is followed by a comparison of sub-step between the value representative of a level of detachment and a predetermined detachment threshold. This representative value is, for example, a measure of maximum detachment between two layers of material as visible on the captured image, or an average detachment between these two layers, calculated following analysis of this captured image.

Preferably, when the construction panel comprises more than two material layers and thus at least two interfaces between two layers, the analysis sub-step provides a value representative of a detachment level for each interface between two layers or for both interfaces between material layers of the material layers of the construction panel, each representative value being compared with the detachment threshold predetermined in the comparison sub-step.

Preferably still, the comparison sub-step is followed by a diagnosis sub-step concluding that there is a bonding fault as soon as at least one representative value supplied by the analysis sub-step is greater than the detachment threshold, or that there is no bonding fault if this is not the case. This diagnosis is displayed on a screen, for example, allowing an operator to eject the panel from the production line in the event of a fault and/or to quickly adjust a parameter of the production line.

The invention also relates to a manufacturing method on a production line for manufacturing construction panels comprising at least two layers of material, the manufacturing method comprising the steps of:
stacking the layers of material, producing a flow of stacked layers of material,
forming a bond between the layers of materials thus stacked, and
cutting the flow of layers of materials stacked and bonded together to form construction panels,
the manufacturing method being characterized in that it implements the checking method according to the invention.

In one embodiment of the invention, said stacked layers of materials are layers of plaster and paper.

The formation step begins as early as the stacking step, since the plaster mixed with water and deposited on a layer of paper may begin to bond with the paper. This forming step, which uses hydration of the materials, may comprise the addition of an additive during a preliminary mixing step of plaster and water. The cutting step may take place during this bond forming step.

Preferably, the step of forming a bond is followed by a step of drying the layers of material, and the detection step takes place between the cutting step and the drying step. In this way, a faulty panel may be detected before moving on to the drying step.

According to an advantageous characteristic of the method for manufacturing construction panels according to the invention, the detection step is followed by a step of ejecting the construction panel from the production line when at least one value representative of a detachment level supplied by the analysis sub-step is greater than an upper threshold. This high threshold corresponds, for example, to a dimension of an inlet mouth of a dryer used during the drying step. In this way, when the detachment is too great, the construction panel is not sent directly into a dryer, where it risks blocking.

According to another advantageous characteristic of the method for manufacturing construction panels according to the invention, the detection step is followed by a step of adjusting at least one parameter of the production line as a function of at least one value representative of a detachment level provided by the analysis sub-step, or as a function of the conclusion of the diagnosis sub-step. This parameter is, for example, when the layers of materials comprise a layer of plaster and layers of paper, a quantity of water used per quantity of dry plaster, during a step of mixing these quantities to form the layer of plaster, prior to the step of stacking the layers of materials. This water/dry plaster ratio is adjusted to encourage the formation of the bond between the plaster layer and the paper layers. If the diagnosis is that there is no bonding fault, this quantity of water used per quantity of dry plaster, for example, is reduced during this adjustment step. The amount of water per amount of dry plaster adjusted here relates to the whole plaster layer or only to one or more interface sub-layers of that plaster layer, at the interface between the plaster layer and one or more layers of material external to that plaster layer. In this case the mixing step may comprise different mixtures, for example an initial mixture of water, wet plaster and any other compounds, configured to form a main inner layer of plaster, this initial mixture then being modified to make the interface sub-layers. The term “mixture” is used here in a broad sense and may be understood as “preparation of a mixture”.

According to an advantageous characteristic of the method for manufacturing construction panels according to the invention, said stacked layers of materials comprise a layer of plaster, and the manufacturing method comprises a plurality of detection steps at a point on the production line on different construction panels arriving successively at that point, and an analysis sub-step providing a value representative of a zero detachment level for each interface between two of the stacked layers of materials is followed by an adjustment step consisting of decreasing a quantity of water used per quantity of dry plaster to form, prior to the step of stacking the layers of materials, a mixture configured to form the layer of plaster or an interface sub-layer of the layer of plaster with another of the stacked layers of materials, said adjustment step being repeated after each subsequent analysis sub-step until a subsequent analysis sub-step provides a value representative of a non-zero detachment level but less than the predetermined detachment threshold. This water reduction therefore affects the entire plaster layer or only one or more interface sub-layers of this plaster layer, at the interface between the plaster layer and one or more layers of materials external to this plaster layer.

In one embodiment of the invention, said stacked layers of materials comprise a layer of plaster, and said at least one parameter is selected from a list comprising:
a ratio between, on the one hand, a quantity of accelerator of a chemical reaction between the water and the plaster of the plaster layer and, on the other hand, a quantity of retarder of a chemical reaction between the water and the plaster of the plaster layer, the quantities of accelerator and retarder being injected into a mixture configured to form the plaster layer during a mixing step prior to the stacking step,
a quantity of foaming agent injected into the mixture,
a quantity of fluidifier injected into the mixture,
a quantity of water used per quantity of dry plaster to form the mixture,
a target density of the plaster layer of the construction panel, and
a target weight of the construction panel.

Several parameters may be adjusted at the same time during this adjustment step. The above list is of course non-exhaustive. The target density is adjusted for example by changing the amount of foaming agent injected in the mixing step, or the amount of water used per amount of dry plaster in the mixing step, which affects the whole plaster layer or only one or more interface sub-layers of that plaster layer, at the interface between the plaster layer and one or more layers of materials external to that plaster layer.

For example, said stacked layers of materials comprise at least one layer of plaster and a layer stacked on the layer of plaster, the layer of plaster comprising a sub-layer interfacing with the layer stacked on the layer of plaster, and said at least one parameter is selected from a list comprising:
a ratio between, on the one hand, a quantity of accelerator of a chemical reaction between the water and the plaster of the interface sub-layer and, on the other hand, a quantity of retarder of a chemical reaction between the water and the plaster of the interface sub-layer, the quantities of accelerator and retarder being injected into a mixture configured to form the interface sub-layer prior to the stacking step,
a quantity of foaming agent injected into the mixture,
a quantity of water used per quantity of dry plaster to form the mixture,
a target density of the interface sub-layer of the construction panel, and
a target weight for the interface sub-layer.

In one embodiment of the invention, the method for manufacturing construction panels according to the invention comprises a plurality of detection steps at a point on the production line on different construction panels arriving successively at this point, and each detection step is followed by a step of adjusting said at least one parameter, the adjustment step using a regulator receiving as input the difference between a current setpoint value of said at least one parameter on the production line, and an estimated value of said at least one parameter on the basis of at least one value representing a level of detachment from the detection step. In other words, in this embodiment of the invention, the adjustment step is performed according to a regulation loop. This, of course, uses a model to estimate a value for the parameter corresponding to a given level of detachment. When several parameters are modified during these adjustment steps, the model comprises as many variables as parameters.

Finally, the invention relates to a device for checking a bond between two layers of materials of a construction panel formed by cutting, on a production line, a flow of layers of materials stacked and bonded together, so as to produce construction panels provided with edges surfaces, the checking device comprising means for detecting a bonding defect between the two layers of materials, and being characterized in that the detection means comprise at least:
means for capturing an image of an edge surface of the construction panel, and
means for analyzing the image thus captured.

Advantageously, the checking device also comprises at least one nozzle for sending gas to the edge surface of the construction panel at a predetermined pressure.

Advantageously, the checking device comprises means for detecting the position of a construction panel on the production line, and means for sending gas as a function of the position detected by said detection means. These gas sending means are, for example, the nozzle or nozzles mentioned above.

Finally, in the checking device according to the invention, a main direction of projection of the gas by the nozzle is preferably oriented facing the edge surface of the construction panel and/or parallel to a longitudinal direction of movement of the construction panel.

The checking device according to the invention comprises advantages similar to those of the checking method according to the invention and the manufacturing method according to the invention.

Other characteristics and advantages of the invention will become apparent from the following description, on the one hand, and from a number of examples of embodiment given by way of indication and without limitation with reference to the attached schematic drawings, on the other hand, wherein:

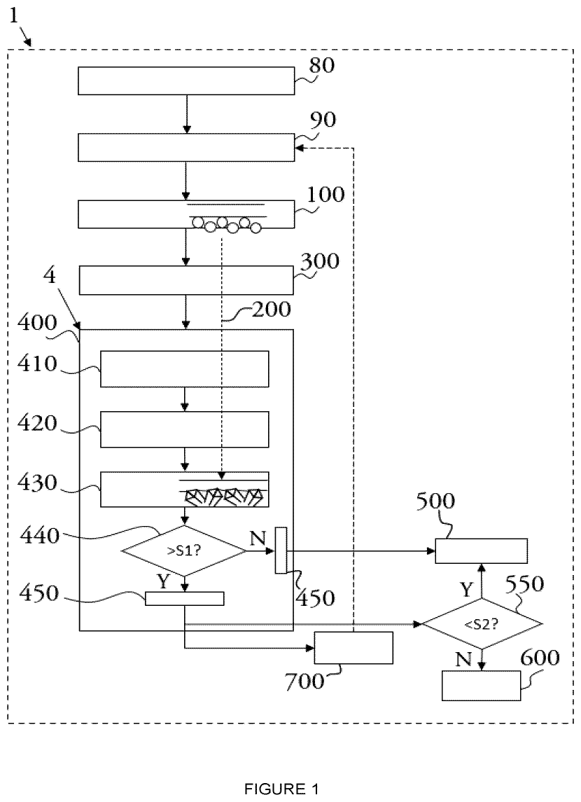

FIG. 1 shows steps in a method for manufacturing construction panels according to the invention, in one embodiment of the invention,

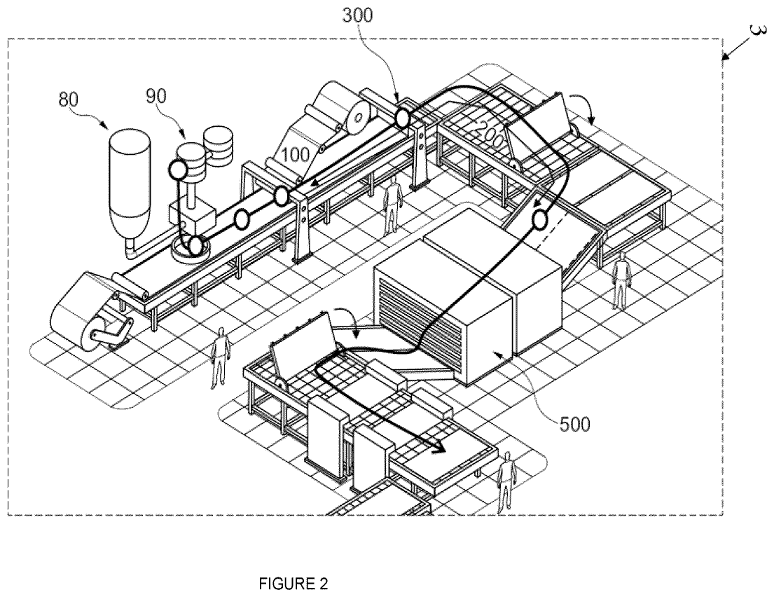

FIG. 2 shows a production line for construction panels according to the invention, in this embodiment of the invention,

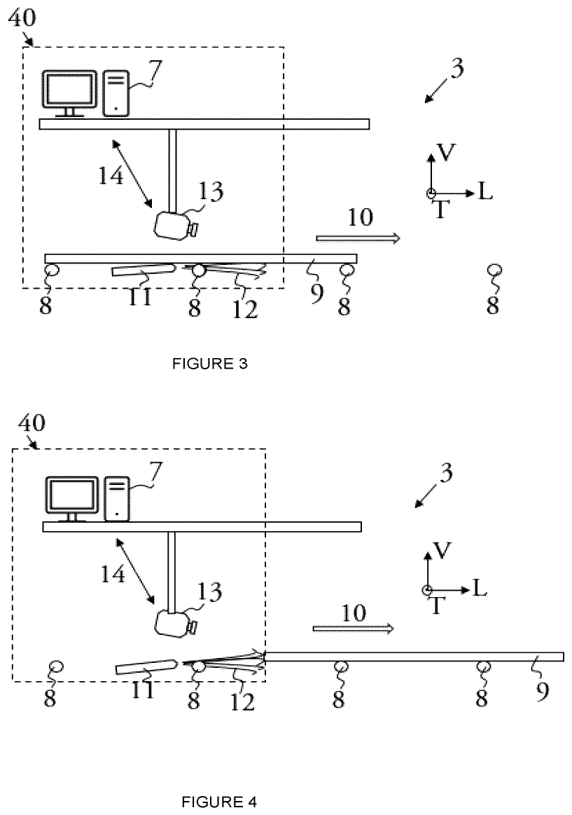

FIG. 3 represents a device for checking a bond between two layers of materials of a construction panel according to the invention, prior to a detection step implemented by this checking device, in this embodiment of the invention,

FIG. 4 represents the checking device of FIG. 3, during a detection step implemented by this checking device, in this embodiment of the invention,

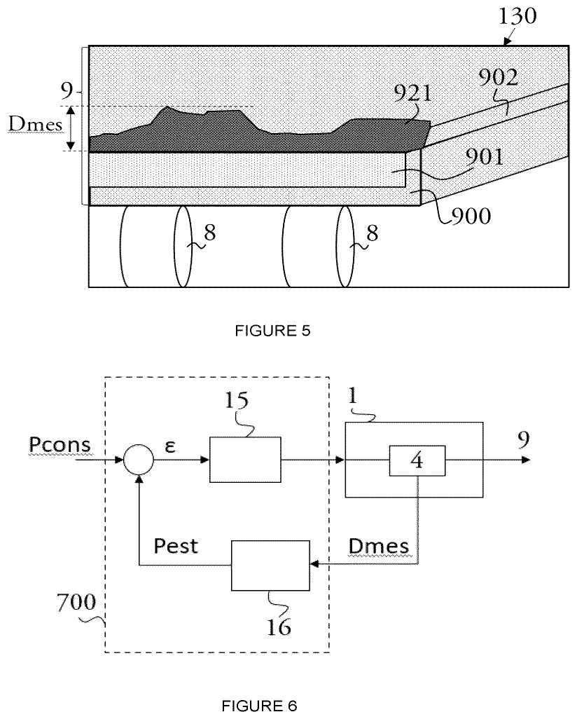

FIG. 5 represents an image taken by the checking device of FIGS. 3 and 4, during a detection step implemented by this checking device, in this embodiment of the invention,

FIG. 6 represents an embodiment of a step for adjusting a parameter of the manufacturing method according to the invention, in the context of the embodiment of the invention, and

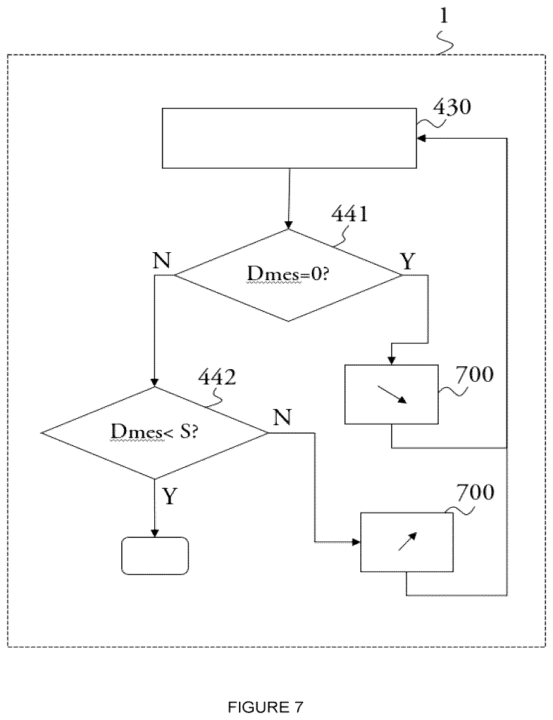

FIG. 7 represents another embodiment of a step for adjusting a parameter of the manufacturing method according to the invention, in another context of the embodiment of the invention.

According to one embodiment of the invention, a manufacturing method 1 for manufacturing construction panels according to the invention is described in relation to FIGS. 1 and 2. More specifically, in this embodiment of the invention, the manufacturing method 1 allows to manufacture plaster panels covered with layers of paper and is implemented by the production line 3 illustrated in FIG. 2. These construction panels are thin rectangular boards comprising an inner layer 901 of plaster (shown in FIG. 5), and outer layers 900, 902 of paper on the surfaces of these boards, each outer layer 900, 902 of paper actually comprising several thicknesses of paper, for example two or three thicknesses of paper.

Referring back to FIGS. 1 and 2, a first step in the manufacturing method according to the invention is the firing 80 of gypsum, which forms the plaster. This first step is followed by a step 90 wherein the plaster thus obtained is mixed with water and any other compounds detailed below. This mixing step 90 produces a wet plaster mixture. Some of this mixture may be taken to modify its properties, for example using specific additives, and is configured to form plaster sub-layers as explained below.

A next step in the manufacturing method according to the invention is the stacking 100 of the layers of materials 900, 901, 902 on the production line 3. To do this, the wet plaster mixture obtained in the mixing step 90 is spread on a first layer 900 of paper, the edges of which are folded so as to contain the mixture, then covered with a second layer 902 of paper, the whole being compressed as these materials advance on the production line 3, by an extruder formed by a pair of rollers allowing the thickness of the stacked layers to be rectified.

In the case where the mixing step 90 comprises a mixture sampling, configured to form in the plaster layer 901 interface sub-layers with the paper layer 900, 902 of compositions or densities different from the rest of the plaster layer 901, the production line 3 comprises one or more specific rollers. These specific rollers are used to spread the mixture sample, which has a different composition or density from the rest of the mixture, onto the paper layer 900, 902, thus forming a wet plaster interface sub-layer on each paper layer 900, 902. Then, in stacking step 100, the rest of the mixture is spread onto the first layer of paper 900 covered with one of the interface sub-layers formed previously. The rest of the mixture thus spread out forms the inner part of the plaster layer 901. This inner part is then covered with the second layer of paper 902, the other of the interface sub-layers previously formed being arranged between the inner part and the second layer of paper 902.

In this stacking step 100, a first layer 900 of paper, a layer 901 of plaster and a second layer 902 of paper are stacked in the following order, this stacking of layers being continuous throughout the manufacturing method 1. The stacking of layers of materials 900, 901, 902 at the output of step 100 therefore produces a flow of layers of materials 900, 901 and 902 which are long.

The deposition of the wet plaster mixture between the paper layers 900 and 902 helps to form a bond between the paper layers 900, 902 and the plaster layer 901. The stacking step 100 is therefore a part of a step 200 of forming a bond between the layers of materials 900, 901, 902. This step 200 of forming a bond is promoted by the hydration of the plaster and paper layers by the water from the mixing step 90. At the interface between the plaster layer 901 and the paper layers 900, 902, this hydration encourages the formation of plaster crystals which, as they harden, surround the fibers of the first layer of paper in the paper layers 900, 902, thus allowing a bond to be formed between the paper layers 900, 902 and the plaster layer 901. This bond ensures a good adhesion between the layers 900, 902 of paper and the layer 901 of plaster. An additive or an accelerator may be added to the water in the plaster mixture during the mixing step 90 prior to the stacking step 100, to promote or accelerate this bond formation respectively. This step 200 of forming a bond therefore comprises the formation of plaster crystals which become entangled around the paper fibers, this formation being completed before the construction panels 9 enter a drying step 500, during which hot air is blown onto the construction panels 9. This drying step 500 allows to remove the excess water added during the mixing step 90 to improve the fluidity of the wet plaster mixture.

The stacking step 100 is followed by a cutting step 300 of the flow of material layers 900, 901, 902 into rectangular construction panels 9 (shown in FIGS. 3 and 4) which move along the production line on rotating rollers 8. By way of illustration, these construction panels 9 are approximately two and a half meters long.

In this embodiment of the invention, the cutting step 300 takes place after the stacking step 100, when the plaster is hard enough, and before the drying step 500.

According to the invention, the manufacturing method 1 also comprises a step 400 of detecting a bonding defect between the layers of materials 900, 901, 902, for example between the layer of plaster 901 and the first layer of paper 900 and/or between the layer of plaster 901 and the second layer of paper 902. This detection is performed on an edge surface of a construction panel 9, i.e. after the cutting step 300.

In this embodiment of the invention, the detection step 400 takes place between the cutting step 300 and the drying step 500, i.e. during the bond forming step 200. This is in fact a “wet” detection. This “wet” detection step 400 is advantageously carried out as close as possible to the cutting device used during the cutting step 300, in order on the one hand to have weaker adhesion and therefore easier to characterize between the plaster layer 901 and the paper layers 900, 902 and on the other hand to allow a rapid ejection of a bad board, and a rapid activation of a feedback loop allowing the manufacturing method 1 according to the invention to be adjusted when a defect is detected, as described below.

In an alternative embodiment of the invention, the detection step 400 takes place after the drying step 500, in which case it is a “dry” detection. The two detections may of course be combined.

This detection step 400 is preferably performed on all the construction panels 9 moving on the production line 3 during the implementation of the production method 1 according to the invention. Alternatively, the detection step 400 is only performed on a sample of construction panels 9, for example only on one construction panel 9 out of ten construction panels running on the production line 3.

The detection step 400 is the main step in a method 4 for checking a bond between two layers of materials in a construction panel 9, implemented in hardware and software by a checking device 40 shown in FIGS. 2 and 3.

The checking device 40 comprises at least one camera 13 attached to a beam and interfaced with a computer 7 via a wireless link 14, for example a Wi-Fi connection using the IEEE 802.11 standard. Preferably several cameras are used to monitor the entire edge surface of the construction panel 9. Preferably also the checking device 40 comprises an illumination system capable of illuminating the edge surface of the panel 9 so that a detachment of a layer of paper 900 or 902 from the layer of plaster 901 forms a shadow between this layer of paper 900 or 902 and the layer of plaster 901, thus facilitating a contour detection performed during an image analysis sub-step described later.

The checking device 40 also comprises at least one nozzle 11 for sending gas, in this case pressurized air 12, against the construction panels 9 arriving on the production line 3. On this production line 3, the construction panels move in a longitudinal direction L in a direction 10 of movement, thanks to the rollers 8. The construction panels 9 were cut in the cutting step 300, in the direction of their width along a transverse direction T orthogonal to the longitudinal direction L and to a vertical direction V.

One or more nozzles 11 are preferably arranged between the rollers 8 of the same section of the production line 3 in the transverse direction T, and are preferably arranged so that their air jets have directions substantially parallel to the longitudinal direction, i.e. parallel to the longitudinal direction L to within a few degrees (for example to within 10 degrees). In this way, their air jets are directed substantially orthogonally to the edges surfaces of the construction panels 9 produced in the cutting step 300. The nozzles 11 are arranged vertically below the camera 13 and longitudinally in the vicinity of the longitudinal position of the camera 13.

In this embodiment of the invention, a single nozzle 11 placed vertically below the vertical position of the construction panel 9 is preferably used, its air jet forming an angle of between 5° and 15° with the longitudinal direction L, for example. This allows to test both the adhesion between the plaster layer 901 and the first paper layer 900, and the adhesion between the plaster layer 901 and the second paper layer 902. This main embodiment is preferred for reasons of cost and simplicity, as only one nozzle is used and the nozzle position 11 does not need to be adjusted according to the thickness of the construction panel 9. However, alternative embodiments are possible, wherein this angle is between 5° and 20°, between 5° and 30°, or between 5° and 45°, for example. Alternatively, the nozzle 11 may only be used to test the adhesion between the layer of plaster 901 and a single layer of paper 900 or 902.

In another embodiment, a nozzle 11 placed vertically above the vertical direction of the construction panel 9 is used, the air jet from this nozzle forming an angle of between 5° and 15°, between 5° and 20°, between 5° and 30°, or between 5° and 45° with the longitudinal direction L. The vertical position of the nozzle 11 is adjusted according to the thickness of the construction panel 9. In this alternative embodiment, the nozzle 11 tests the adhesion between the plaster layer 901 and each of the paper layers 900, 902, or between the plaster layer 901 and a single paper layer 900, 902. Finally, combinations of these variants are conceivable, wherein two nozzles are used, one placed vertically below the vertical position of the construction panel 9, and the other placed vertically above the vertical position of the construction panel 9.

In FIG. 3, for example, the construction panel 9 is moistened and has just passed through the cutting step 300, and the air 12 sent through the nozzles 11 reaches below the surface of the construction panel 9. In FIG. 4, on the other hand, the nozzles 11 blow the air 12 towards an edge surface of the construction panel 9 moving in the direction of travel 10. This air 12 is preferably sent at a pressure slightly higher than atmospheric pressure, for example two bars. This relative air pressure 12 (i.e. added to atmospheric pressure) at the outlet of the nozzles 11 is predetermined and is between 1 and 6 bar.

The air 12 leaving the nozzles 11, for example, is continuously sent at the same pressure as it passes through the construction panels 9.

Alternatively, the pressure of the air 12 at the outlet of the nozzles 11 changes according to a rising pressure ramp, when the checking method is configured to associate a pressure threshold with a detachment of one of the paper layers 900, 902 from the plaster layer 901. This pressure threshold allows to quantify the level of adhesion between this layer of paper 900 or 902 and the layer of plaster 901. This configuration is activated, for example, by an operator, the checking device comprising a man-machine interface, in particular a screen allowing the detachment of one of the layers of paper 900 or 902 from the layer of plaster 901 to be viewed using the camera 13. This screen may also be used to display the measurements and diagnostics resulting from the detection step 400, as described below. These measurements and diagnostics are displayed for each construction panel 9 checked by the checking method according to the invention, one diagnostic and one measurement preferably being displayed for the bond between the first paper layer 900 and the plaster layer 901, and another diagnostic and another measurement being displayed for the bond between the second paper layer 902 and the plaster layer 901.

It is also preferable for the nozzles 11 to send air 12 only when the edge surface of a construction panel 9 is facing the nozzles 11. To do this, a position sensor for the panel 9 on the production line 3 interacts with the nozzles 11 by means of the computer 7.

Returning to FIG. 1, the detection step 400 comprises a first sub-step of sending 410 air 12 through the nozzles 11 onto the edge surface of a construction panel 9 facing the nozzles 11.

The next sub-step is the capture 420 of an image of the edge surface of the construction panel 9 by the camera 13. The air 12 blown onto the edge surface of the construction panel 9 allows one of the layers of paper 900 or 902 to be detached off the layer of plaster 901 when the bond between the layers of paper 900 and plaster 901, or between the layers of paper 902 and plaster 901, is not sufficient to allow a good adhesion of the paper to the plaster.

The capture sub-step 420 therefore provides an image 130 shown in FIG. 5, wherein a detachment 921 between the plaster layer 901 and the paper layer 902 is potentially indicative of a poor adhesion between the paper layer 902 and the plaster layer 901. The image 130 is displayed on the screen of the checking device 40. In this example of use of the checking method according to the invention, it may be seen that the paper layer 900 is not detached from the plaster layer 901, indicating a good adhesion between these two layers 900 and 901.

The next sub-step is the analysis 430 of the image 130 obtained during the previous capture sub-step 420. This image analysis uses a contour detection to identify the different layers of the construction panel 9, and the detachment 921 between the paper layer 902 and the plaster layer 901. This contour detection is followed, in this analysis sub-step 430, by a measurement Dmes of the maximum detachment visible on the image 130, between the layers of material 901 and 902 of the construction panel 9. This measurement is representative of a level of detachment between the material layers 901 and 902 of the construction panel 9. In this analysis sub-step 430, a further contour measurement between the material layers 900 and 901 gives a zero value for the maximum detachment between these material layers 900 and 901.

Given that in this example of embodiment of the invention, only the second layer of paper 902 is detached from the layer of plaster 901, it will be detailed in the following of the description of the checking method and of the manufacturing method only the steps and sub-steps of these methods relating to this detachment 921 will be described in detail below, these steps and sub-steps being transposable to the case where the plaster layer 901 and the first paper layer 900 are also detached from each other, or to the case where both the first paper layer 900 and the second paper layer 902 are both detached from the plaster layer 901.

In an alternative embodiment of the invention, this analysis sub-step 430 provides an average value of a detachment between the paper layer 902 and the plaster layer 901 over at least a part of the edge surface of the construction panel 9. This average value is also representative of a level of detachment between the material layers 901 and 902 of the construction panel 9. In another embodiment, the analysis sub-step 430 provides a value of an area of detachment between the material layers 901 and 902 of the construction panel 9, which area value may also be considered as a value representative of a level of detachment between the material layers 901 and 902 of the construction panel 9.

The next sub-step is the comparison 440 between a value of the maximum detachment measurement Dmes and a predetermined detachment threshold S1. This predetermined detachment threshold S1 is set, for example, at 2 mm (millimeters). Preferably this predetermined detachment threshold S1 is between 1 mm and 4 mm. Alternatively, the detachment threshold S1 is, for example, 1 mm, 3 mm or 4 mm.

In the alternative embodiment of the invention using an average value of a detachment between the paper layer 902 and the plaster layer 901, the comparison sub-step 440 compares this average value with a predetermined detachment threshold S1 set, for example, at 1 mm.

The next sub-step is a diagnosis 450 concluding that there is a bonding fault or no bonding fault between the layers of materials whose detachment was measured in the analysis sub-step 430. In this diagnostic sub-step 450, if at step 440 the value representative of a maximum level of detachment (therefore the maximum detachment measurement Dmes or the average detachment value in the corresponding embodiment) is greater than the predetermined detachment threshold S1 (branch Y at the output of step 440 in FIG. 1), then the diagnostic sub-step 450 concludes that there is a bonding fault between the plaster layer 901 and the paper layer 902, otherwise (branch N at the output of step 440 in FIG. 1) the diagnostic sub-step 450 concludes that there is no bonding fault between the plaster layer 901 and the paper layer 902. In the latter case, the next step is the drying step 500. The diagnosis resulting from the diagnosis sub-step 450 is displayed on the screen of the checking device according to the invention.

In this embodiment of the invention, when the diagnostic sub-step 450 concludes that there is a bonding fault between the plaster layer 901 and the paper layer 902, the detection step 400 is followed by a step 550 of comparing the value representing a maximum level of detachment with an upper threshold S2 corresponding to a maximum detachment value acceptable for allowing the construction panel 9 to pass through a dryer. This high threshold S2 may be equal to the predetermined detachment threshold S1 (in which case step 550 is not necessary, the diagnosis sub-step 450 then being followed by a step 600 of ejecting the construction panel 9 from the production line 3 as soon as a bonding fault is detected), but is preferably strictly greater than the predetermined detachment threshold S1. In this embodiment of the invention, this high threshold S2 is set at 6 mm. Alternatively, it may be set at 3, 4 or 5 mm, while always remaining above the predetermined detachment threshold S1, which in these variants is, for example, 1, 3 or 4 millimeters respectively.

If the step 550 of comparing the value representative of a maximum level of detachment with an upper threshold S2 determines that this representative value is greater than the upper threshold S2, then (branch N at the output of step 550) the next step is a step 600 of ejecting the construction panel 9 from the production line 3. In this way, the faulty construction panel 9 does not pass to the drying step 500, which it would risk blocking, due to the narrowness of the dryer mouths used during this drying step 500.

If, on the other hand, the step 550 of comparing the value representative of a maximum detachment level with an upper threshold S2 determines that this representative value is less than the upper threshold S2, then (branch Y at the output of step 550) the next step is the drying step 500.

In addition, in this embodiment of the invention, the detection step 400 may be followed by a step 700 of adjusting a parameter of the production line 3. This adjustment step is conditional on the value representative of a detachment level obtained during the analysis sub-step 430, or at the conclusion of the diagnosis sub-step 450. The adjustment step 700 is activated, for example, as soon as a bonding fault is diagnosed in the diagnosis sub-step 450. In particular, in order to keep the value representative of a detachment level below the predetermined threshold S1, or another threshold lower than this predetermined threshold S1, this other threshold then corresponding to a target detachment threshold, one or more the following parameters are modified during this adjustment step 700, which are listed here in order of preference:
a quantity of accelerator for the formation of plaster crystals in the plaster layer 901, added during the mixing step 90. Such an accelerator speeds up the formation of hydrated calcium sulphate from the calcium sulphate hemihydrate present in the plaster and the water during the mixing step 90. This accelerator is, for example, a Heat Resistant Accelerator (HRA) such as small gypsum crystals;
a quantity of plaster crystal formation retarder in the plaster layer 901, added during the mixing step 90. Such a retarder, well known to the person skilled in the art, allows to delay the formation of hydrated calcium sulphate during the mixing step 90, and is used on the one hand to prevent lumps from forming in the mixing apparatus used during this mixing step 90, which would necessitate stopping the production line, and on the other hand so that the mixture resulting from this step is not too viscous to be able to spread it on the layer of paper 900;
a quantity of foaming agent injected during the mixing step 90, this foaming agent forming a stable or unstable foam; as this quantity increases, the adhesion between the paper and the plaster is potentially reduced. Preferably, a foaming agent is used which produces an unstable foam, or a mixture of unstable foam and stable foam;
a target density of the plaster layer 901 of the construction panel 9. The greater the density, the better the adhesion between the layers of paper 900 or 902 and the layer of plaster 901. For example, the density of the plaster layer is increased or decreased by increasing or respectively decreasing the quantity of water used per quantity of dry plaster during the mixing step 90. However, increasing this quantity of water means increasing the energy used during the drying step 500 of the construction panels. Therefore, preferably, rather than the density of the plaster layer, the density of the plaster sub-layers at the interface of the plaster layer 901 with the paper layers 900 and 902, referred to above in connection with the mixing 90 and stacking 100 steps, is modified by modifying, in these plaster sub-layers, the quantity of water per quantity of dry plaster in these sub-layers. Another way of modifying the density of the plaster layer 901 of the construction panel 9, is to inject more or less air into this plaster layer, using a foaming agent as previously mentioned. Preferably when this latter solution is chosen, only the densities of the plaster sub-layers at the interface of the plaster layer 901 with the paper layers 900 and 902 are modified, which means that the density of a construction panel 9 as a whole is not significantly changed;
a quantity of water used per quantity of dry plaster during the mixing step 90; in fact, below a critical value of this water/dry plaster ratio, the adhesion between the layers of paper 900 or 902 and the layer of plaster 901 is not satisfactory. On the other hand, too high a water/dry plaster ratio deteriorates the strength of the paper and therefore the interface between the layers of paper 900 or 902 and the layer of plaster 901. Preferably, this quantity of water is used as a parameter in the adjustment step 700 only when the production line 3 comprises the specific rollers referred to above, in order to modify only the quantity of water used in the portion of mixture sampled in the mixing step 90 and forming the plaster sub-layers at the interface of the plaster layer 901 with the paper layers 900 and 902;
a quantity of additive promoting the bond between the layers of paper 900 or 902 and the layer of plaster 901, injected during the mixing step 90. This quantity of additive may relate only to interface sub-layers between the plaster layer 901 and the paper layers 900, 902;
a duration of the bond forming step 200, which may be modified by adjusting the speed of the production line 3;
a target weight of the construction panel 9, achieved in particular by modifying a flow rate of air injected into the plaster mixture during the mixing step 90; the greater the amount of air injected, the poorer the adhesion between the paper layers 900 or 902 and the plaster layer 901. Preferably, this target weight is used as a parameter during the adjustment step 700, only when the production line 3 comprises the specific rollers mentioned above, in order to modify only the quantity of air injected into the plaster sub-layers at the interface of the plaster layer 901 with the paper layers 900 and 902;
a quantity of fluidifier injected into the mixture. This liquefier is an additive which may be added to the mixture formed in mixing step 90 to make the mixture more fluid and therefore easier to spread over the paper layers 900, 902 without adding more water to this wet plaster mixture.

It should be noted that the mixture of plaster and water produced in step 90 also advantageously comprises starch, which is an additive that promotes bonding between the layers of paper 900 or 902 and the layer of plaster 901, but only on drying. The starch contained in the mixture migrates to the interface between the plaster and paper layers and gels during the drying step 500. In the embodiment where the detection step 400 takes place after the drying step 500, the amount of starch in the mixture at step 90 may therefore be adjusted in this step 700.

In addition, since it is the correct balance between the amount of accelerator and retarder which improves the adhesion of the plaster layer 901 to the paper layers 900, 902 without adversely affecting the fluidity of the wet plaster mixture made in step 90, the parameters of amount of accelerator and retarder are alternatively replaced by a parameter which is a ratio between an amount of accelerator and retarder, used in the mixing step 90.

In this embodiment of the invention, when the value representative of a level of detachment obtained during the analysis sub-step 430 is greater than the predetermined detachment threshold S1, or the target detachment threshold, several adjustment steps 700 are implemented after as many detection steps performed successively on different construction panels 9. These adjustment steps 700 are repeated until the value representative of a detachment level obtained during a last analysis sub-step 430 becomes less than or equal to the predetermined detachment threshold S1 or the target detachment threshold. These adjustment steps 700 modify a setpoint value Pcons of one of the aforementioned parameters for improving the adhesion between the layers of materials 901 and 902, for example a quantity of water per quantity of dry plaster during the mixing step 90, using a regulator 15 shown in FIG. 6, this regulator being, for example, of the Proportional, Integral, Derivative type (also referred to as PID). This quantity of water per quantity of dry plaster corresponds to that used to form the plaster layer 901 or plaster sub-layers at the interface between the plaster layer 901 and the paper layers 900, 902.

During an adjustment step 700, the regulator PID receives as input a difference between a current setpoint value Pcons for the parameter on the production line 3, and an estimated value Pest for the parameter on the basis of the value representing a level of detachment from the detection step 400 preceding the adjustment step 700. This estimate Pest of the value of the parameter, here a quantity of water per quantity of dry plaster, uses a model 16, giving the quantity of water per quantity of dry plaster used during the mixing step 90 as a function of the value representative of a level of detachment. This model is obtained empirically, for example.

In this embodiment of the invention, when the value representative of a level of detachment obtained during the analysis sub-step 430 is zero, i.e. the layers of materials 901 and 902 are not detached from each other on the edge surface of the panel 9 checked during the detection step 400, one or more adjustment steps 700 are performed to reduce the quantity of water per quantity of dry plaster used during the mixing step 90.

In this case, as shown in FIG. 7, the adjustment steps 700 are repeated until the value representative of a detachment level obtained in a last analysis sub-step 430 becomes non-zero but less than or equal to the predetermined detachment threshold S1 or the target detachment threshold.

More precisely, after an analysis sub-step 430 of the manufacturing method 1, in a first comparison sub-step 441, it is checked whether the value representative of a detachment level obtained in the analysis sub-step 430 is zero.

If this is the case (branch Y in FIG. 7), the quantity of water per quantity of dry plaster used in the mixing step 90 is reduced, and this first comparison sub-step 441 is repeated in a subsequent analysis sub-step 430.

If, on the other hand, the value representative of a detachment level obtained during the analysis sub-step 430 is non-zero (N branch in FIG. 7), a second comparison sub-step 442 checks whether the value representative of a detachment level obtained during the analysis sub-step 430 is less than or equal to the predetermined detachment threshold S1 or the target threshold. If this is the case (Y branch in FIG. 7), the adjustment step 700 is no longer repeated at least until a subsequent detection step 400 diagnoses a bonding fault between the layers of materials 900, 901 and 902, or provides a value representative of a zero level of detachment. If this is not the case (branch N in FIG. 7), the quantity of water per quantity of dry plaster used in mixing step 90 is increased using the regulation loop in FIG. 6.

Of course, the invention is not limited to the examples just described and many adjustments may be made to these examples without departing from the scope of the invention.

1. A method for checking a bond between at least two layers of materials of a construction panel formed by cutting, on a production line, a flow of layers of materials stacked and bonded together, so as to produce construction panels provided with edges surfaces, the checking method comprising a step of detecting a bonding defect between the two layers of materials, wherein the detection step comprises the following sub-steps:
capturing an image of an edge surface of the construction panel, and
analyzing the image thus captured.

2. The method for checking a bond according to claim 1, wherein the sub-step of capturing an image is preceded by a sub-step of sending a gas onto the edge surface of the construction panel.

3. The method for checking a bond according to claim 2, wherein during the sub-step of sending the gas, the gas is sent at a predetermined pressure of between 1 and 6 bars.

4. The method for checking a bond according to claim 1, wherein the analysis sub-step provides a value representative of a level of detachment between the two layers of materials over at least a part of the edge surface, and is followed by a comparison sub-step between the value representative of a level of detachment and a predetermined detachment threshold.

5. The method for checking a bond according to claim 4, wherein the construction panel comprises more than two material layers and wherein the analysis sub-step provides a value representative of a detachment level for each interface between two material layers of the material layers of the construction panel, each representative value being compared with the detachment threshold predetermined in the comparison sub-step.

6. The method for checking a bond according to claim 4, wherein the comparison sub-step is followed by a diagnosis sub-step concluding that there is a bonding fault as soon as at least one representative value supplied by the analysis sub-step is greater than the detachment threshold, or that there is no bonding fault if this is not the case.

7. A manufacturing method on a production line for manufacturing construction panels comprising at least two layers of materials, the manufacturing method comprising steps of:
stacking the layers of materials, producing a flow of stacked layers of materials,
forming a bond between the layers of materials thus stacked, and
cutting the flow of layers of materials stacked and bonded together to form construction panels.
wherein the manufacturing method being characterized in that it implements the checking method according to claim 1.

8. The method for manufacturing construction panels according to claim 7, wherein the step of forming a bond being followed by a step of drying the layers of materials, the detection step takes place between the cutting step and the drying step.

9. The method for manufacturing construction panels according to claim 7, wherein said stacked layers of materials are layers of plaster and paper.

10. The method for manufacturing construction panels according to claim 7,
wherein the analysis sub-step provides a value representative of a level of detachment between the two layers of materials over at least a part of the edge surface, and is followed by a comparison sub-step between the value representative of a level of detachment and a predetermined detachment threshold,
wherein the detection step is followed by a step of ejecting the construction panel from the production line when at least one value representative of a detachment level supplied by the analysis sub-step is greater than an upper threshold.

11. The method for manufacturing construction panels according to claim 7,
wherein the analysis sub-step provides a value representative of a level of detachment between the two layers of materials over at least a part of the edge surface, and is followed by a comparison sub-step between the value representative of a level of detachment and a predetermined detachment threshold,
wherein the detection step is followed by a step of adjusting at least one parameter of the production line as a function of at least one value representative of a detachment level provided by the analysis sub-step, or as a function of the conclusion of the diagnosis sub-step.

12. The method for manufacturing construction panels according to claim 11, wherein said stacked layers of materials comprise a layer of plaster, and wherein said at least one parameter is selected from a list comprising:
a ratio between a quantity of accelerator of a chemical reaction between the water and the plaster of the plaster layer and a quantity of retarder of a chemical reaction between the water and the plaster of the plaster layer, the quantities of accelerator and retarder being injected into a mixture configured to form the plaster layer during a mixing step prior to the stacking step,
quantity of foaming agent injected into the mixture,
a quantity of fluidifier injected into the mixture,
a quantity of water used per quantity of dry plaster to form the mixture,
a target density of the plaster layer of the construction panel, and
a target weight of the construction panel

13. The method for manufacturing construction panels according to claim 11, wherein said stacked layers of materials comprise at least one layer of plaster and a layer stacked on the layer of plaster, the layer of plaster comprising a sub-layer interfacing with the layer stacked on the layer of plaster, and wherein said at least one parameter is selected from a list comprising:
a ratio between a quantity of accelerator of a chemical reaction between the water and the plaster of the interface sub-layer and a quantity of retarder of a chemical reaction between the water and the plaster of the interface sub-layer, the quantities of accelerator and retarder being injected into a mixture configured to form the interface sub-layer prior to the stacking step,
a quantity of foaming agent injected into the mixture,
a quantity of water used per quantity of dry plaster to form the mixture,
a target density of the interface sub-layer of the construction panel, and
a target weight for the interface sub-layer.

14. The method for manufacturing construction panels according to claim 11,
wherein the analysis sub-step provides a value representative of a level of detachment between the two layers of materials over at least a part of the edge surface, and is followed by a comparison sub-step between the value representative of a level of detachment and a predetermined detachment threshold.,
wherein the construction panel comprises more than two material layers and wherein the analysis sub-step provides a value representative of a detachment level for each interface between two material layers of the material layers of the construction panel, each representative value being compared with the detachment threshold predetermined in the comparison sub-step,
wherein said stacked layers of materials comprise a layer of plaster, the manufacturing method comprising a plurality of detection steps at a point on the production line on different construction panels arriving successively at that point, and wherein an analysis sub-step providing a value representative of a zero detachment level for each interface between two of the stacked layers of materials is followed by an adjustment step consisting of decreasing a quantity of water used per quantity of dry plaster to form, prior to the step of stacking the layers of materials, a mixture configured to form the layer of plaster or an interface sub-layer of the layer of plaster with another of the stacked layers of materials, said adjustment step being repeated after each subsequent analysis sub-step until a subsequent analysis sub-step provides a value representative of a non-zero detachment level but less than the predetermined detachment threshold.

15. A device for checking a bond between two layers of materials of a construction panel formed by cutting, on a production line, a flow of layers of materials stacked and bonded together, so as to produce construction panels provided with edges surfaces, the checking device comprising means for detecting a bonding defect between the two layers of materials, wherein the detection means comprise at least:
means for capturing an image of an edge surface of the construction panel, and
means for analyzing the image thus captured.

16. The device for checking a bond according to claim 15, further comprising at least one nozzle for sending gas to the edge surface of the construction panel at a predetermined pressure.

17. The device for checking a bond according to claim 16, comprising a means for detecting the position of a construction panel on the production line, and means for sending gas as a function of the position detected by said detection means.

18. The device for checking a bond according to claim 15, wherein a main direction of projection of the gas by the nozzle is oriented facing the edge surface of the construction panel and/or parallel to a longitudinal direction of movement of the construction panel.
